(19) United States
(12) Patent Application Publication
(10) Pub. No.: US 2020/0264209 A1
(43) Pub. Date: Aug. 20, 2020

(54) SYSTEM AND METHOD FOR DETERMINING WIND DIRECTION AND VELOCITY MEASUREMENT FROM ALTITUDE FOR AN UNMANNED AERIAL VEHICLE

(71) Applicant: Hoverfly Technologies, Inc., Orlando, FL (US)

(72) Inventors: ALFRED D. DUCHARME, Oviedo, FL (US); ROBERT TOPPING, St. Charles, MO (US)

(21) Appl. No.: 16/789,961

(22) Filed: Feb. 13, 2020

Related U.S. Application Data
(60) Provisional application No. 62/806,559, filed on Feb. 15, 2019.

(51) Int. Cl. G01P 5/02; G01P 13/02; B64C 39/02; B64C 19/00; G05D 1/10

(52) U.S. Cl. CPC G01P 5/02; G01P 13/025; G01C 17/02; B64C 19/00; G05D 1/106; B64C 39/024

(57) ABSTRACT

Wind speed and direction experienced by the UAV at altitude is determined by placing an accelerometer, gyroscope and compass on the UAV. A change in velocity experienced by the UAV is determined by the accelerometer. An orientation relative to a reference plane and an angular velocity experienced by the UAV is determined by the gyroscope. A magnetic bearing of the UAV is determined with the compass. A roll and pitch exhibited by the UAV is determined as a function of the change in velocity, orientation and change in angular velocity. Projected roll and projected pitch vectors onto a horizontal plane cutting through the center of rotation of the UAV are determined as a function of the roll and the pitch. The wind speed of the wind experienced by the UAV is determined as a function of the projected roll vector and projected pitch vector. The wind direction is determined as a function of the projected roll vector and projected pitch vector and the magnetic bearing of the UAV.

### CROSS REFERENCE TO RELATED APPLICATION

This application claims prior to U.S. Provisional Application No. 62/806,559 filed Feb. 15, 2019, the contents of which are herein incorporated.

### BACKGROUND OF THE INVENTION

The present invention relates to an Unmanned Aerial Vehicle (“UAV”), and more particularly a structure and method for indirectly determining wind forces, as a function of wind direction and velocity, in which the UAV is traveling.

UAVs, whether flying to a destination, or attempting to maintain a fixed position relative to the ground, must maintain speed and direction relative to an input flight path and/or a fixed ground position. When a UAV flies through the air and interacts with wind it must compensate roll and pitch, known collectively as the “attitude”, to maneuver and maintain its position. To accomplish this, wind speed and direction must be determined so that corrective action to maintain desired position and heading may be performed as needed.

To measure wind velocity utilizing mechanical sensors such as a wind vane or spinning anemometer is well known in the art. Such devices, if used on the ground, are not predictive of wind velocity at altitude because wind velocity at the ground is not the same as wind velocity experienced by the UAV at altitude. Furthermore, such prior art wind detection devices are large and heavy making them inapplicable to UAVs which must conserve weight and space in their design to account for energy usage, payload requirements, maneuverability and other physical factors during flight.

It is also known to utilize ultrasonic transducers to measure change of path length over known distances as compared to a predicted position. However these also suffer from the disadvantage that they are heavy, add on board weight and take up on board space.

Accordingly, there is a need for a structure and methodology for indirectly sensing wind direction and speed which overcomes the shortcomings of the prior art.

### SUMMARY OF THE INVENTION

Wind speed and direction experienced by the UAV at altitude is determined by placing an accelerometer, gyroscope and compass on the UAV. A change in velocity experienced by the UAV is determined by the accelerometer. An orientation relative to a reference plane and an angular velocity experienced by the UAV is determined by the gyroscope. A magnetic bearing of the UAV is determined with the compass. A roll and pitch exhibited by the UAV is determined as a function of the change in velocity, orientation and change in angular velocity. Projected roll and projected pitch vectors onto a horizontal plane cutting through the center of rotation of the UAV are determined as a function of the roll and the pitch. The wind speed of the wind experienced by the UAV is determined as a function of the projected roll vector and projected pitch vector. The wind direction is determined as a function of the projected roll vector and projected pitch vector and the magnetic bearing of the UAV.

### BRIEF DESCRIPTION OF THE DRAWINGS

The features and advantages of the present invention will become more readily apparent from the following detailed description of the invention in which like elements are labeled similarly and in which:

FIG. 1 is a schematic diagram of a an unmanned aerial vehicle constructed in accordance with the invention; and

FIG. 2 is a schematic diagram of a system for determining the wind direction and velocity of a UAV constructed in accordance with the invention; and

FIG. 3 is flowchart for a method of determining wind direction and velocity in accordance with the invention.

### DETAILED DESCRIPTION OF THE PREFERRED EMBODIMENTS

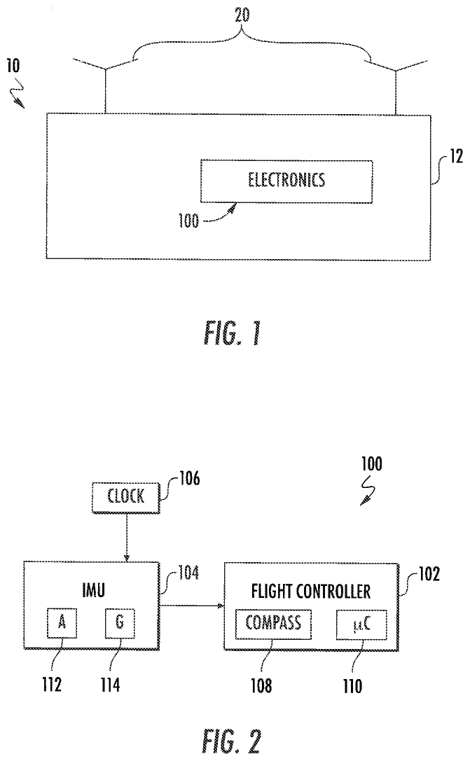

Reference is initially made to FIG. 1 in which a UAV, generally indicated as 10, constructed in accordance with the invention is provided. UAV 10 includes a platform 12 in the form of an enclosure. As known in the art, rotors 20 extend from platform 12. Electronics 100, including structures for determining roll and pitch of the UAV, are mounted within housing 12.

Reference is now made to FIG. 2 in which the structure for electronics 100 is provided with greater particularity. Electronics 100 includes a flight controller 102 which, as known in the art, receives control signals for governing flight of UAV 10 transmitted either wireles sly or through a tether to ground. Flight controller 102 sends rotor control signals to rotors 20, as known in the art, which operates in response to the received control signals. Flight controller 102 includes a device, such as a compass 108, in one nonlimiting exemplary embodiment, for determining the magnetic bearing of UAV 10. Flight controller 102 also includes a microcontroller 110 operating as discussed below.

Electronics 100 also includes an inertial motion unit (IMU) 104 for determining roll and pitch of UAV 10. To determine motion in three dimensions, IMU 104 includes a three-dimensional accelerometer 112 which measures changes in velocity (speed and direction), and a gyroscope114 which determines orientation relative to a reference plane and angular velocity of UAV 10. Together they determine roll, pitch, yaw and velocity of UAV 10. Accelerometer 112 and gyroscope 114 may be MEMs; thus reducing the space and weight taken up by the wind detection apparatus. IMU 104 provides a motion output (roll, pitch, yaw and velocity) to flight controller 102, which as discussed below is used to determine wind direction and velocity and make corrections therefore.

The amount of roll and pitch will differ between different UAV designs as a function of aerodynamics, mass and other factors. In a first step, changes in the roll, pitch, and magnetic bearing of the UAV in response to known wind conditions are measured directly to determine a correction factor. Next, an average roll and average pitch in response to a known wind condition are determined. This can be determined utilizing electronics 100 with the following equations:

θ_{Roll,Average}=Σᵢ₌₀ⁿθ_{Roll} (1)

θ_{Pitch,Average}=Σᵢ₌₀ⁿθ_{Pitch} (2)

Where n is the number of samples and can be found by the sample rate and desired duration of the average.

The projected vectors onto the horizontal plane are then determined as follows:

R̅=sin θ_{Roll,Average} (3)

P̅=sin θ_{Pitch,Average} (4)

Where R̅ and P̅ represent the projected roll and pitch vectors respectively onto a horizontal plane cutting through the center of rotation of the UAV.

The present inventor has determined that the wind velocity can be determined as a function of a correction value and the projected roll and pitch vectors (R̅,P̅) onto the horizontal plane cutting through the center of rotation of UAV 10. The correction value is a fixed a number which changes as a function of the make and model of UAV 10. As a result, wind velocity can be determined by electronics 100 in accordance with the following equation:

Wind Velocity=W_{correction}\sqrt{R̅²+P̅²} (5)

Where W_{correction} is the wind correction factor for each unique UAV design; determined as discussed above.

The wind direction may also be determined from the same information and as a function of the magnetic bearing of UAV 10 as determined by compass 108. Compass 108 provides a true orientation relative to the ground (magnetic bearing). Wind direction can be determined in accordance with the following equation:

Wind Direction=H+tan⁻¹(R⁻/P⁻) (6)

Where H is the magnetic bearing of the craft as determined by compass 108.

4851-4859-1796.1 5

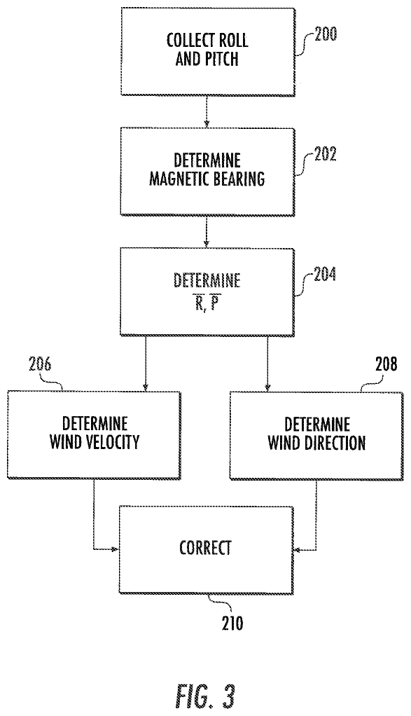

As a result of the inventive use of on board lightweight, circuit-based, electronics such as accelerometer 112, gyroscope 114 and compass 108, microcomputer 110 is enabled to determine the wind direction and velocity at altitude being experienced by UAV 10 in real time and provide correction instructions for flight controller 102 relative to the desired ground position or flight path. Reference is now made to FIG. 3 in which the method is described in greater detail.

In a step 200, a clock 106 providing an input to IMU 104 starts a timing period for accelerometer 112 and gyroscope 114 to begin measuring roll and pitch. The roll and pitch measurements are collected over a period of time, such as 30 seconds, so that normal attitude changes due to normal flight can be discriminated from long-term offsets due to wind. At the end of the time period clock 106 outputs a signal causing IMU 104 to output the measured roll and pitch as determined by accelerometer 112 and gyroscope 114 to microcontroller 110. In a step 202, a magnetic bearing is determined by compass 108 and is input to micro controller 110 along with the outputs of accelerometer 112 and gyroscope 114 for the time period determined by clock 106.

In a step 204, micro controller 110 determines the projected vectors (R̅,P̅) in accordance with the equations (3) and (4). In a step 206 microcontroller 110 determines the wind velocity experienced by UAV 10 utilizing the equation (5). In a step 208 microcontroller 110 determines wind direction utilizing the determined projected vectors in accordance with the equation (6). Applicant notes that steps 206 and 208 can occur simultaneously or in any order relative to the other. The wind velocity and wind direction are utilized to determine a correction value for flight controller 102 to adjust the operation of rotors 20 to compensate for the wind being experienced by UAV 10. Accordingly, as a result of the inventive use of onboard electronics such as accelerometer 112, gyroscope 114 and compass 108, UAV 10 is capable of determining wind speed and direction at altitude from previously determined attitude measurements and makes real time corrections to resume the desired flight path/positioning. As result, space, weight and aerodynamics are conserved at the UAV level.

It is also to be understood that the operations discussed above in connection with electronics 100 can also be accomplished at the microcontroller level. Microcontroller 110 may incorporate the accelerometer and gyroscope to determine roll and pitch without the need for IMU 104.

It should be further recognized that the invention is not limited to the particular embodiments described above. Accordingly, numerous modifications can be made without departing from the spirit of the invention and scope of the claims appended hereto.

What is claimed is:

1. A method for determining wind speed and wind direction experienced by an unmanned aerial vehicle at altitude comprising the steps of:
placing an accelerometer, a gyroscope and a compass on the unmanned aerial vehicle;
determining a change in velocity experienced by the unmanned aerial vehicle with the accelerometer;
determining an orientation of the unmanned aerial vehicle relative to a reference plane and an angular velocity experienced by the unmanned aerial vehicle with the gyroscope;
determining a magnetic bearing of the unmanned aerial vehicle with the compass;
determining a projected roll vector and a projected pitch vector onto a horizontal plane cutting through the center of rotation of the unmanned aerial vehicle as a function of the roll and pitch of the unmanned aerial vehicle in response to known wind conditions;
determining a wind speed of a wind experienced by the unmanned aerial vehicle as a function of the projected roll vector and the projected pitch vector; and
determining a wind direction as a function of the projected roll vector, projected pitch vector and magnetic bearing of the unmanned aerial vehicle.

2. The method for determining wind speed and wind direction experienced by an unmanned aerial vehicle at altitude of claim 1, wherein the accelerometer is a three-dimensional accelerometer.

3. The method for determining wind speed and wind direction experienced by an unmanned aerial vehicle at altitude of claim 1, further comprising the step of determining a correction value as a function of measuring changes in the roll, pitch and magnetic bearing of the unmanned aerial vehicle in response to known wind conditions; the wind velocity being determined in part as a function of the correction value.

4. The method for determining wind speed and wind direction experience by an unmanned aerial vehicle at altitude of claim 3, wherein the correction value is a fixed value assigned to an unmanned aerial vehicle which is specific to a make and model of a respective unmanned aerial vehicle.

5. The method for determining wind speed and wind direction experienced by an unmanned aerial vehicle at altitude of claim 1, further comprising the step of determining a predetermined time period and determining the roll, and the pitch during the predetermined time period.

6. A system for determining wind speed and wind direction experienced by an unmanned aerial vehicle at altitude comprising:
an accelerometer being disposed on the unmanned aerial vehicle and determining a change in velocity experienced by the unmanned aerial vehicle;
a gyroscope being disposed on the unmanned aerial vehicle and determining an orientation of the unmanned aerial vehicle relative to a reference plane and an angular velocity experienced by the unmanned aerial vehicle;
a compass being disposed on the unmanned aerial vehicle and determining a magnetic bearing of the unmanned aerial vehicle;
a flight controller in communication with the compass, the gyroscope, and accelerometer; the flight controller receiving the magnetic bearing and determining a projected roll vector and a projected pitch vector onto a horizontal plane cutting through the center of rotation of the unmanned aerial vehicle as a function of the roll and pitch respectively; determining a wind speed of a wind experienced by the unmanned aerial vehicle as a function of the projected roll vector and the projected pitch vector; and determining a wind direction as a function of the projected roll vector, projected pitch vector and magnetic bearing of the unmanned aerial vehicle.

7. The system for determining wind speed and wind direction experienced by an unmanned aerial vehicle at altitude of claim 6, wherein the microcontroller determines the wind speed and wind direction utilizing a correction value as a function of measured changes in the roll, pitch and magnetic bearing of the unmanned aerial vehicle in response to known wind conditions; the correction value being a fixed value assigned to an unmanned aerial vehicle which is specific to a make and model of a respective unmanned aerial vehicle.

8. The system for determining wind speed and wind direction experienced by an unmanned aerial vehicle at altitude of claim 6, further comprising a clock; the clock out putting timing signals during a predetermined time period, the accelerometer and gyroscope only providing outputs to the flight controller during the predetermined time period.
